(19) United States
(12) Patent Application Publication
(10) Pub. No.: US 2009/0051541 A1
(43) Pub. Date: Feb. 26, 2009

(54) RFID CERTIFIED DOCUMENT AND ITS PREPARING METHOD

(76) Inventors: Cho-Lan Peng, Jhubei City (TW); I-Ju Fu, Longtan Shiang (TW); Pao-Cheng Hsiao, Jhubei City (TW); Yung-Chih Lo, Pusin Township (TW)

Correspondence Address: SINORICA, LLC, 528 FALLSGROVE DRIVE, ROCKVILLE, MD, 20850, US

(21) Appl. No.: 12/176,524

(22) Filed: Jul. 21, 2008

(30) Foreign Application Priority Data
Aug. 22, 2007 (TW) 096131035

(51) Int. Cl. G08B 13/14

(52) U.S. Cl. 340/572.7

(57) ABSTRACT

A RFID certified document preparing method includes the steps of: (1) providing a medium and printing an antenna on the medium, (2) printing document data on the medium, and (3) electrically connecting a chip to the antenna via a pad. The invention also provides a RFID certified document prepared according to this method.

### BACKGROUND OF THE INVENTION

1. Field of the Invention

The present invention relates to a radio frequency identification technology and more particularly, to a RFID certified document and its preparing method. The preparation of a RFID certified document includes the step of printing an antenna on a blank document sheet, the step of printing document data on the blank document sheet, and the step of electrically connecting a chip to the antenna via a pad.

2. Description of the Related Art

Currently, checking the authenticity of a contract or license is made manually by means of visual sense and/or touch sense. Further, when checking the authenticity of a contract or license, a magnifier or ultraviolet lamp may be necessary. This conventional checking method consumes much labor and cost. Further, this manual checking method has a high false positive rate.

A RFID (radio-frequency identification) tag is to be applied to or incorporated into a product for the purpose of identification using radiowaves. A RFID tag can record product provider, manufacturing process, product flow quality, and etc., for different control purposes. By means of a specific code, a RFID tag provides an anti-fake function. Therefore, RFID tags are intensively used in contract documents and licenses to gain anti-counterfeit security. According to current techniques, a RFID tag is directly embedded in a blank sheet for contract document or license. When a staff uses a laser printer to print data on a blank sheet for contract document or license, the high temperature or pressure of the laser printer may damage the chip of the embedded RFID tag, loosing the anti-counterfeit security function of the RFID tag. During printing, the chip of the RFID tag may damage the surface of the roll of the laser printer, causing printer failure. Therefore, an improvement in this regard is necessary.

### SUMMARY OF THE INVENTION

The present invention has been accomplished under the circumstances in view. It is one object of the present invention to provide a RFID certified document and its preparing method, which has an antenna be printed on the document to be certified before printing of document data, and a chip be electrically connected to the antenna via a pad to form an anti-counterfeit document.

It is another object of the present invention to provide a RFID certified document and its preparing method, which eliminates the change of damage of the chip of the RFID tag by the high temperature and high pressure of the laser printer and the change of damage of the roll of the laser printer by the chip of the RFID tag.

To achieve these and other objects of the present invention, the RFID certified document preparing method includes the steps of: (1) providing a medium and printing an antenna on the medium, (2) printing document data on the medium, and (3) electrically connecting a chip to the antenna via a pad.

To achieve these and other objects of the present invention, the RFID certified document comprises a printable medium, an antenna provided at the printable medium, a chip electrically connected to the antenna via a pad for transmitting/ receiving data through the antenna, and a document data printed on the printable medium so that the printable medium and the antenna and the chip constitute a RFID certified document.

### BRIEF DESCRIPTION OF THE DRAWINGS

FIG. 1 is a RFID certified document preparation flow chart in accordance with the present invention.

FIG. 2 is a schematic drawing, illustrating an antenna printed on a blank sheet of paper according to the present invention.

FIG. 3 is a schematic drawing, illustrating document data printed on the blank sheet of paper according to the present invention.

FIG. 4 is a schematic drawing, illustrating a chip electrically connected to the antenna via a pad according to the present invention.

FIG. 5 is a schematic drawing, illustrating a steel seal stamped on the document around the chip according to the present invention.

### DETAILED DESCRIPTION OF THE PREFERRED EMBODIMENT

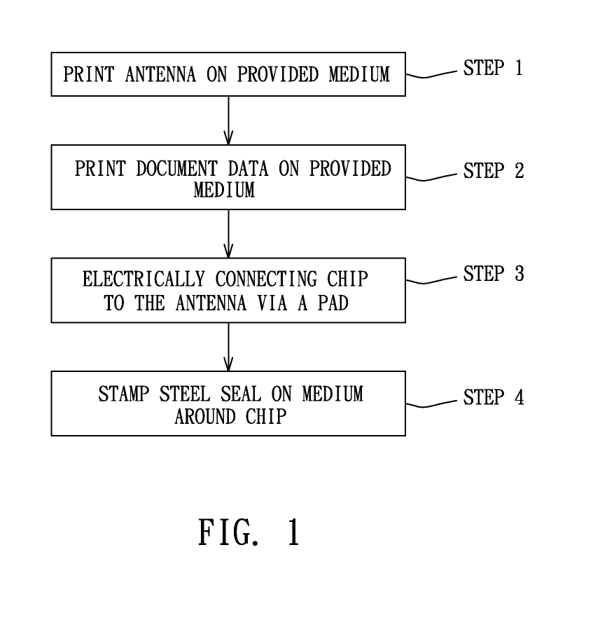

Referring to FIG. 1, a RFID certified document preparing method in accordance with the present invention is shown comprising the steps of: (1) providing a medium 20 and printing an antenna 10 on the medium 20, (2) printing document data on the medium 20, and (3) electrically connecting a chip 30 to the antenna 10 via a pad. Thus, a RFID certified document is obtained.

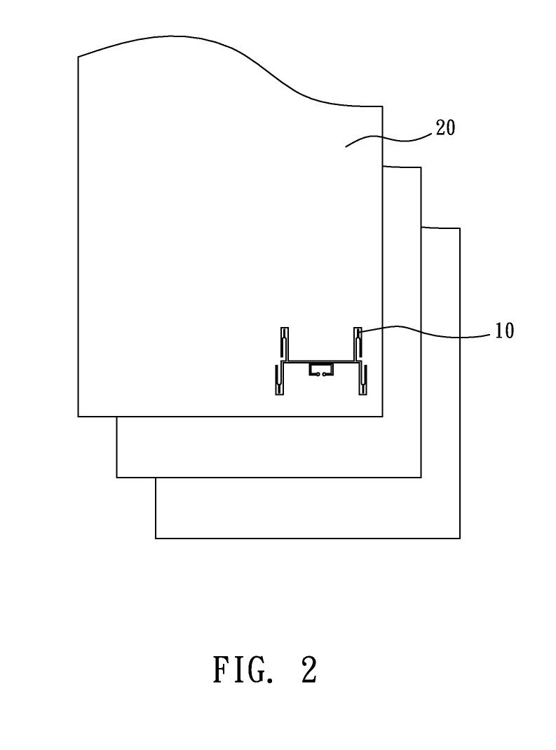

During step (1), an antenna 10 is printed on a medium 20. The antenna 10 can be printed on the inside or surface of the medium 20. The medium 20 can be a sheet of paper, plastic film, or any printable substrate. According to this embodiment, the medium 20 is a sheet of paper for document or license, and the antenna 10 is printed on the surface of the sheet of paper at one corner, for example, the lower right corner (please see FIG. 2).

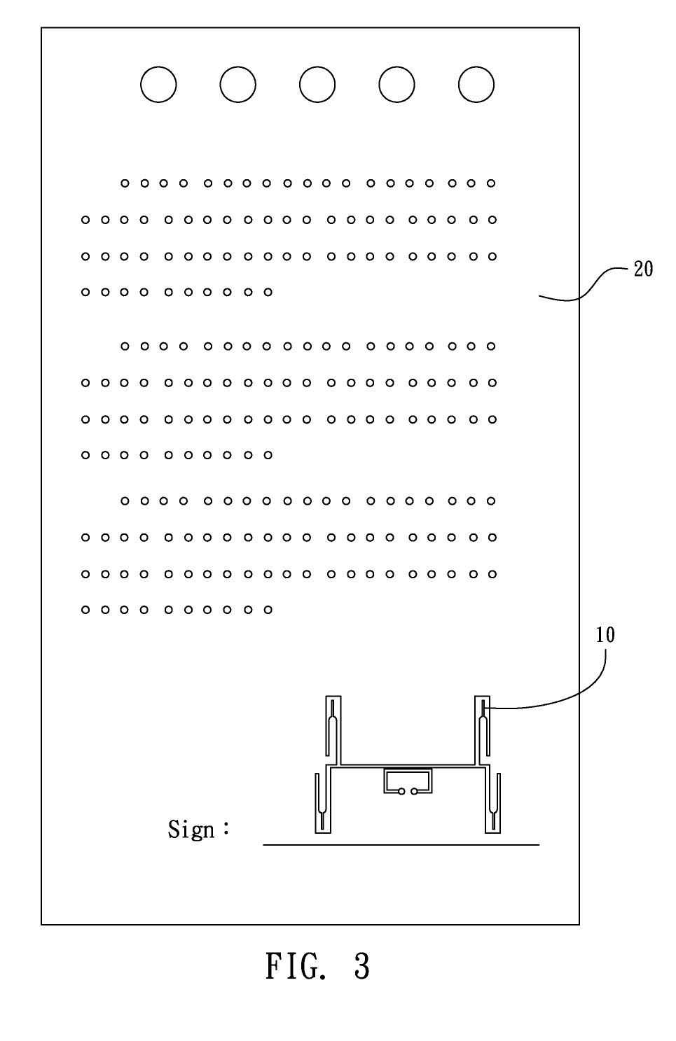

During step (2), document data is printed on the sheet of paper 20 by means of any of a variety of printing machines (please see FIG. 3). According to this embodiment, a laser printer is used to print document data on the sheet of paper 20.

During step (3), a chip 30 is electrically connected to the antenna 10 via a pad (not shown), forming a RFID certified document. The chip 30 according to this embodiment is a RFID chip carrying a unique ID (identification). The chip 30 is electrically connected to the antenna 10 by means of, for example, a handheld binder, so that the chip 30 can be communicated with a RFID scanner (not shown) through the antenna 10 for authenticity recognition.

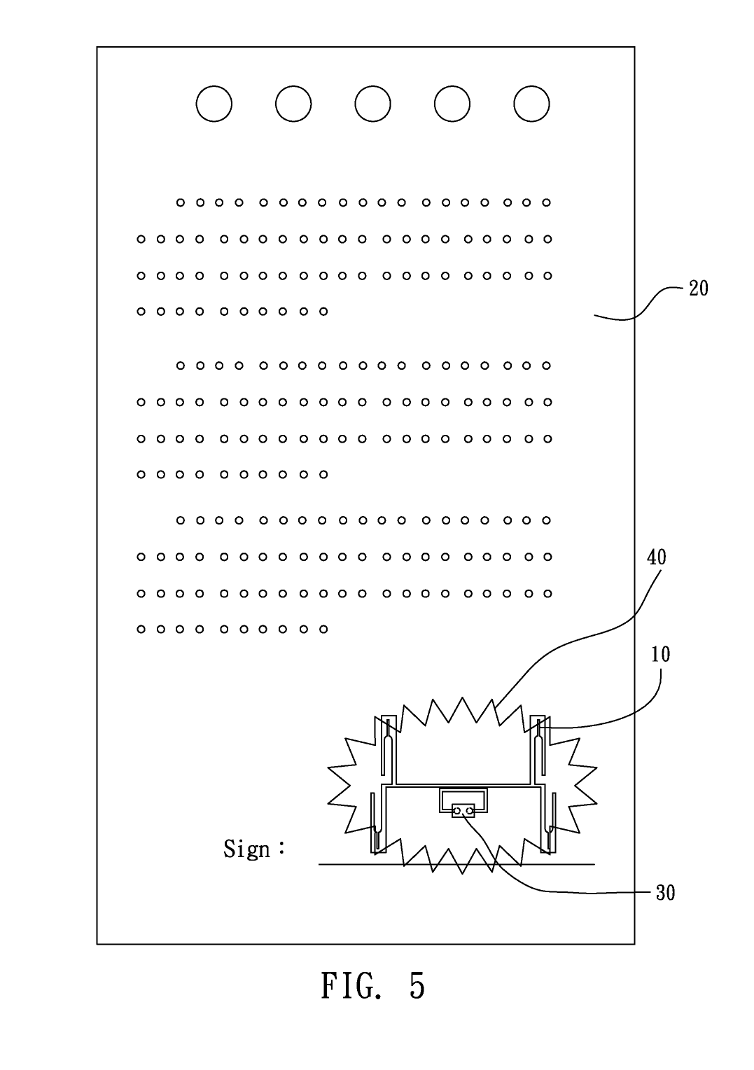

The RFID certified document preparing method further comprises step (4) stamping a steel seal 40 on the sheet of paper 20 around the chip 30 (please see FIG. 5), enhancing the certification effect.

Therefore, the preparing method of a RFID certified document according to the present invention is to print an antenna 10 on a blank sheet of paper 20, and then to print document data on the blank sheet of paper 20, and then to electrically connect a chip 30 to the antenna 10 via a pad, and then stamp a steel seal 40 on the sheet of paper 20 around the chip 30. The chip 30 carries a unique ID. By means of using a RFID scanner to read the ID carried in the chip 30, the authenticity of the document is recognized. Because document data is printed on the blank sheet of paper 20 with a laser printer before electrically connecting of the chip 30 to the antenna 10 via a pad, the high temperature and high pressure of the laser printer does not cause damage to the chip 30. Therefore, the preparation of a RFID certified document according to the present invention is inexpensive, and false positive rate is greatly lowered, i.e., the invention effectively eliminates the drawback of the prior art method.

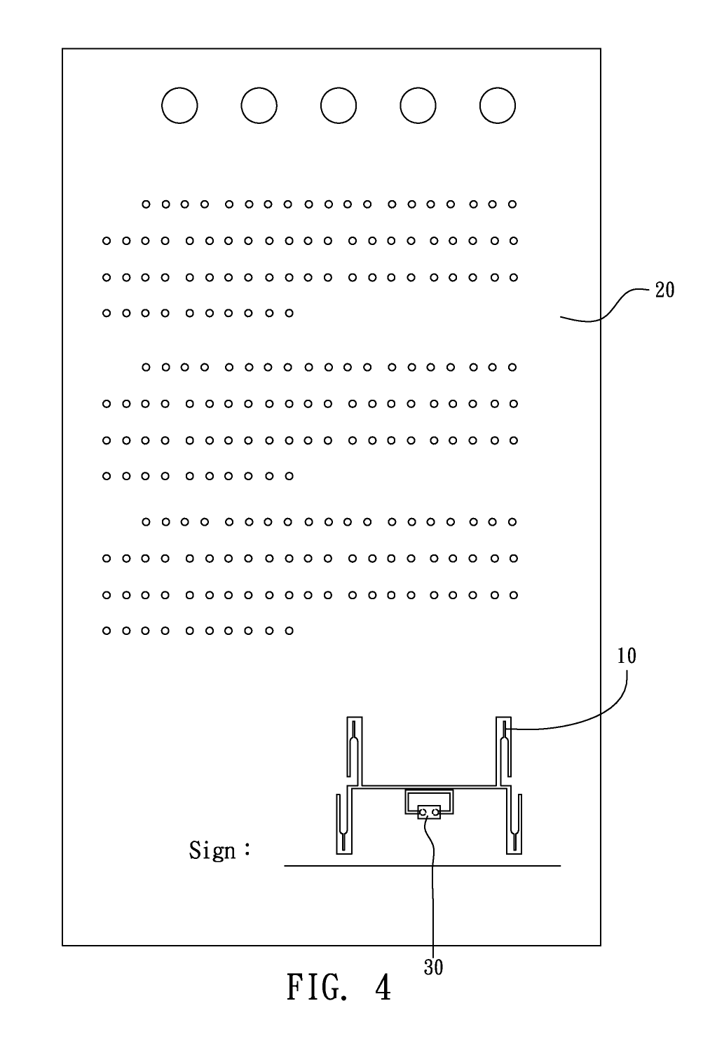

Referring to FIGS. 2-5, a RFID certified document comprises an antenna 10, a medium 20, and a chip 30. The antenna 10 is printed on the inside or surface of the medium 20 at the right lower corner, left lower corner, or any desired location. According to this embodiment, the antenna 10 is printed on the inside or surface of the medium 20 at the right lower corner.

The medium 20 can be a printable medium, for example but not limited to a document or license prepared from paper or plastic film. According to this embodiment, the medium 20 is a paper license.

The chip 30 according to this embodiment is a RFID (radio frequency identification) chip, carrying a unique ID (identification). The chip 30 is electrically connected to the antenna 10 by, for example, a handheld binder (not shown), allowing communication of the chip 30 with a RFID scanner (not shown) through the antenna 10 for authenticity recognition.

Further, a steel seal 40 may be stamped on the medium 20 around the chip 30 to enhance the anti-counterfeit and recognition effect.

When preparing a license, an antenna 10 is printed on the inside or surface of a paper sheet 20, and then the document data, i.e., the content of construction license or graduation certificate is printed on the paper sheet 20, and then a chip 30 is electrically connected to the antenna 10 via a pad, and then a steel seal 40 is stamped on the paper sheet 20 around the chip 30, and an anti-counterfeit license is thus obtained. Because the chip 30 of the anti-counterfeit license carries a unique ID (identification), the authenticity of the anti-counterfeit license can be recognized by means of a RFID scanner. Because document data is printed on the paper sheet 20 with a laser printer before electrically connecting of the chip 30 to the antenna 10 via a pad, the high temperature and high pressure of the laser printer does not cause damage to the chip 30. Therefore, the invention lowers the cost and false positive rate, eliminating the drawback of the prior art technique.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A method for preparing a RFID certified documents comprising the steps of:
(1) providing a medium and printing an antenna on said medium;
(2) printing document data on said medium; and
(3) electrically connecting a chip to said antenna via a pad.

2. The RFID certified document preparing method as claimed in claim 1, wherein the step (1) preparing a medium and printing an antenna on said medium is to print said antenna on the inside or surface of said medium.

3. The RFID certified document preparing method as claimed in claim 1, wherein the step (1) preparing a medium and printing an antenna on said medium is to prepare a blank paper sheet for contract/license and then to print an antenna on the blank paper sheet.

4. The RFID certified document preparing method as claimed in claim 1, wherein the step (2) printing document data on said medium is to use a printer to print said document data on said medium, and the printer is a laser printer.

5. The RFID certified document preparing method as claimed in claim 1, wherein the step (3) electrically connecting a chip to said antenna via a pad is to electrically connect a RFID (radio frequency identification) chip to said antenna via said pad.

6. The RFID certified document preparing method as claimed in claim 1, wherein the step (3) electrically connecting a chip to said antenna is to use a handheld binder to electrically connect a chip to said antenna.

7. The RFID certified document preparing method as claimed in claim 1, wherein the step (1) preparing a medium and printing an antenna on said medium is to prepare a medium and to print an antenna on the prepared medium at the lower right corner or lower left corner of the prepared medium.

8. The RFID certified document preparing method as claimed in claim 1, further comprising step (4) stamping a steel seal on said medium around said chip.

9. The RFID certified document preparing method as claimed in claim 1, wherein the step (1) preparing a medium and printing an antenna on said medium is to prepare a paper or a plastic film and to print an antenna on said plastic film.

10. A RFID certified document comprising:
a printable medium;
an antenna provided at said printable medium;
a chip electrically connected to said antenna via a pad for transmitting/receiving data through said antenna; and
a document data printed on said printable medium so that said printable medium and said antenna and said chip constitute a RFID certified document.

11. The RFID certified document as claimed in claim 10, wherein said antenna is a radio frequency antenna disposed at one of lower right corner and lower left corner of said medium.

12. The RFID certified document as claimed in claim 10, wherein said printable medium is a blank paper sheet for contract/license.

13. The RFID certified document as claimed in claim 10, wherein said document data is printed on said printable medium by means of a printer.

14. The RFID certified document as claimed in claim 13, wherein said printer is a laser printer.

15. The RFID certified document as claimed in claim 10, wherein said chip is a RFID (radio frequency identification) chip.

16. The RFID certified document as claimed in claim 10, wherein said chip is bonded to the ends of said antenna by means of a handheld binder.

17. The RFID certified document as claimed in claim 10, further comprising a steel seal stamped on said printable medium around said chip.

18. The RFID certified document as claimed in claim 10, wherein said printable medium is a paper or plastic film.
